(19) United States
(12) Patent Application Publication
(10) Pub. No.: US 2020/0211053 A1
(43) Pub. Date: Jul. 2, 2020

(54) METHOD AND SYSTEM FOR DETERMINING FACT OF VISIT OF USER TO POINT OF INTEREST

(71) Applicant: YANDEX EUROPE AG, Luzern (CH)

(72) Inventors: Alexandr Leonidovich SHISHKIN, Moscow (RU); Irina Anatolievna GOLTSMAN, Moscow (RU); Danil Vadimovich PETROV, Cheboksary (RU); Denis Evgenievich SHAPOSHNIKOV, Krasnodarsky kray (RU)

(21) Appl. No.: 16/573,204

(22) Filed: Sep. 17, 2019

(30) Foreign Application Priority Data
Dec. 26, 2018 (RU) 2018146461

(51) Int. Cl. G06Q 30/02; G06N 20/00

(52) U.S. Cl. CPC G06Q 30/0246; G06N 20/00; G06Q 30/0261; G06Q 30/0256

(57) ABSTRACT

A method of determining a fact of a visit of a user to a point of interest (POI) includes receiving a geo-track generated by a wireless device of the user, generating, based on the geo-track, a dwell profile indicative of the wireless device having been in a pre-defined vicinity of the location of the POI over a pre-determined timeframe, and inputting the dwell profile into a specifically trained Machine Learning Algorithm (MLA). Based on the dwell profile, the MLA returns an indication of whether the user visited the POI. A system and server for executing the method are also provided.

### CROSS-REFERENCE

The present application claims priority to Russian Patent Application No. 2018146461, filed Dec. 26, 2018, entitled “METHOD AND SYSTEM FOR DETERMINING FACT OF VISIT OF USER TO POINT OF INTEREST”, the entirety of which is incorporated herein.

### FIELD

The present technology relates to computer implemented methods and systems for determining facts of visits of users to points of interests.

### BACKGROUND

Wireless devices, such as smartphones and Wi-Fi™ enabled tablets are ubiquitously used by users. Many such wireless devices include one or more geo-location systems, such as one or more Global Positioning Systems (GPS), that enable the wireless devices to determine their own geo-location.

For various uses and applications, it may be desirable to determine from the geo-locations of users, either in real time or by processing existing geo-track data provided by the users' wireless devices, when the users are visiting various Points of Interest (POIs). Examples of POIs may include parks or other attractions, businesses, private residences, and so on. In some cases, it may be desirable to determine, from the geo-locations of users, either in real time or by processing existing geo-track data provided by the users' wireless devices, the name and/or other information relating to each particular POI the users are visiting.

The prior art geo-location systems, including the geo-location systems of the wireless devices themselves, are suitable for such purposes at least in some cases. For example, many prior art geo-location systems are typically suitable to determine when a given user is visiting a large park that has few or no other POIs nearby. In such a situation, a given wireless device may determine its geo-location with a relatively high level of certainty, compared to when the same device may be located in a highly dense urban geographical area having a large number of POIs nearby.

In other circumstances, however, prior art geo-location systems may be inaccurate, and in some particular cases simply non-usable. For example, the denser a given geographical area visited by a user is in terms of the number of POIs in the area, the less reliable prior art geo-location systems tend to be due at least in part to increasing uncertainties related to the accuracy of the geo-locations provided by such geo-location systems and due to an increasing number of possible POIs that a user may be visiting in any given geo-location.

Some geo-location systems have been developed to improve upon at least some of the drawbacks described above.

For example, U.S. Pat. No. 9,639,858 B2, entitled “SYSTEMS AND METHODS TO ATTRIBUTE REAL-WORLD VISITS OF PHYSICAL BUSINESS LOCATIONS BY A USER OF A WIRELESS DEVICE TO TARGETED DIGITAL CONTENT OR PUBLICLY DISPLAYED PHYSICAL CONTENT PREVIOUSLY VIEWABLE BY THE USER”, and assigned to Facebook Inc., teaches methods and systems that record the location of a user and transmit targeted content to a user based upon their current and past location information. A network is configured to include a server programmed with a database of targeted content, a database of location information, a database of user information, a database searching algorithm, and a wireless communication system capable of communicating with the user's mobile device. The location of the mobile device is ascertained and recorded. The location information is analyzed to determine the routes taken by the user, businesses visited by the user, and other behaviors of the user. Targeted content is sent to the mobile device of the user or exposure to physical content is tracked. Whether the user visits the physical locations associated with the content is monitored. Detailed conversion tracking is provided to producers of targeted content and business owners.

As another example, U.S. Pat. No. 9,135,655 B2, entitled “SYSTEMS AND METHODS FOR USING SERVER SIDE COOKIES BY A DEMAND SIDE PLATFORM”, and assigned to MediaMath Inc., teaches methods for identifying a user by a demand side platform (DSP) across advertiser exchanges. The method includes establishing, by a DSP, a cookie mapping for a user. The cookie mapping includes a mapping of user identifiers for the user from advertisement exchanges to a user identifier assigned by the DSP for the user. The DSP stores to the cookie mapping a first mapping to the user identifier of the DSP, comprising a first user id received by a bidder from a first exchange and a first exchange id for the first exchange. A bidder inserts a pixel into a bid for an impression opportunity to a second exchange. The pixel includes a key to the cookie mapping and a second user id for the user and a second exchange id. The second user id is received by the bidder from a second exchange.

As yet another example, Patent Application Number US 2009/0234745 A1, entitled “METHODS AND SYSTEMS FOR MOBILE COUPON TRACKING”, and assigned to Millennial Media LLC, teaches a method and system for presenting a sponsored mobile coupon to a mobile communication facility based at least in part on a relevancy, wherein the relevancy is based at least in part on a mobile subscriber characteristic, redeeming the coupon at an offline sponsor location using the mobile communication facility, recording conversion of the coupon in a conversion data repository, transmitting the conversion data repository to a wireless carrier, and analyzing the conversion data repository to determine an action.

While these other prior art systems and methods described above may be suitable for at least some of their intended purposes, they nonetheless have their own drawbacks.

### SUMMARY

The present technology has been developed with a view to improving at least upon some of the drawbacks of prior art geo-location systems for at least some particular applications.

In summary, the present technology provides methods and systems for determining facts of visits by identified, or identifiable, users to identified, or identifiable, points of interest (POIs). The methods and systems use a particularly configured Machine Learning Algorithm (MLA) which determines the facts of visits of a given one or more users based on dwell profiles associated with the given one or more users' wireless devices. In some particular non-limiting embodiments of the present technology, the systems include a server that is used to develop a particular training dataset and train the MLA using the particular training dataset.

In some such embodiments, the server executes a dwell profile module, a training dataset generating module, and an MLA training module. Each of these modules is described in detail in later in this document. At least one non-limiting embodiment of each of the modules is summarized herein next. It should be understood that while a particular set of modules is described in this document, the functionality achieved thereby may be achieved using a different set of modules and/or configurations of the server.

In summary, the dwell profile module accesses wireless devices of users in a particular geographical area of interest, and obtains timestamped geo-tracks from each of these wireless devices over a period of time. These geo-tracks represent sequences of geo-locations as detected and/or reported by the wireless devices at particular times over the period of time. Based on the geo-tracks, the dwell profile module generates a plurality of dwell profiles. Each of the dwell profiles of a wireless device is indicative of the wireless device having been in a pre-defined vicinity of a given location over a pre-determined timeframe.

In summary, the training dataset generating module analyzes a subset of geo-tracks associated with the geographical area, to generate a plurality of training dwell profiles. For each training dwell profile, the dataset generating module applies a set of heuristics that determines if a user of a wireless device associated with the training dwell profile has or has not visited a given POI in the geographical area. The training dataset generating module labels each training dwell profile with a training label that is indicative of the result of the set of heuristics applied to that training dwell profile. The training dataset generating module thereby generates an MLA training dataset.

In summary, the MLA training module feeds the MLA training dataset to the MLA, with the training dwell profiles and the training labels being inputs to train the MLA to predict the fact of the visit (the “target”). The MLA training module thereby trains the MLA to determine a fact of a visit by a user to a POI in the geographical area based on a dwell profile associated with a wireless device of the user.

In use, the trained MLA may receive as input a given dwell profile. In some cases, the MLA may receive a series of dwell profiles, corresponding to different times at which the given wireless device reported its geo-location. In some cases, the series of dwell profiles may correspond to the user of the wireless device moving around and spending time in different locations in the geographical area of interest. For each dwell profile input, the MLA determines whether or not the user is visiting a given one of the POIs in the geographical area at the time associated with the dwell profile.

In at least some cases, training the MLA on the dwell profiles of the present technology and subsequently using the MLA with new dwell profiles as inputs helps increase an accuracy of the determinations by the MLA in comparison with prior art technologies which do not use and MLA and simply map a user's location to one or more POIs. More particularly, the dwell profiles may help distinguish times when a given user simply walks by, or even through, a given POI without visiting the POI, from other times when a given user is in fact visiting a given POI. Thus, in at least some cases where a prior art technology might provide a false-positive determination of a visit to a POI, the present technology may provide a correct negative determination. In other instances when there is in fact a visit to a POI, the present technology may provide a correct positive determination. Further, in at least some cases when a user is visiting a geographical area that has a high density of POIs, prior art technology may provide incorrect determinations for at least some of the POIs. In contrast, the present technology for at least some such cases may provide a correct determination.

With the above summary in mind, and according to a first aspect of the present technology, there is provided a method of determining a fact of a visit of a user to a point of interest (POI), the user using a wireless device having a geo-location module and a wireless device identifier, the POI being in a location, the method being executed at a server having a processor and a non-transient memory communicatively coupled to the processor, the non-transient memory storing processor-executable instructions thereon for executing the method.

In some embodiments, the method includes: receiving during an in-use phase, at the server, the wireless device identifier of the wireless device; receiving during the in-use phase, at the server based on the wireless device identifier, a geo-track generated by the wireless device; generating, based on the geo-track, a dwell profile of the wireless device of the user, the dwell profile being indicative of the wireless device of the user having been in a pre-defined vicinity of the location of the POI over a pre-determined timeframe; and inputting, by the server into a Machine Learning Algorithm (MLA) as an in-use input, the dwell profile of the wireless device of the user.

In some embodiments, the MLA had been trained based on a training dataset, a given training object of the training dataset having been generated by: identifying a training set of sequential timestamped geo-tracked locations of a training wireless device associated with a training user based on a training wireless device identifier of the training wireless device, determining, based on the training sequential set of the geo-tracked locations, a training dwell profile of the training wireless device, the training dwell profile being indicative of the training wireless device having been in the pre-defined vicinity of the location of the POI over a pre-determined training timeframe, and applying a set of heuristics to the training sequential set of the geo-tracked locations and a user profile associated with the training user to generate a training label indicative of whether the training user has visited the location of the POI, thereby generating the given training object having the training dwell profile and the training label.

In some embodiments, the method may further include receiving during the in-use phase, by the server from the MLA as an in-use output based on the dwell profile, an indication of whether the user visited the POI.

In some embodiments, the generating the dwell profile of the wireless device comprises: analyzing the geo-track generated by the geo-location module, the geo-track having a set of timestamped geo-tracked locations received from the geo-location module of the wireless device; and the set of timestamped geo-tracked locations including a sequential set of the geo-tracked locations that are both within the pre-defined vicinity of the location of the POI and have timestamps that correspond to the pre-determined timeframe.

In some embodiments, the user profile comprises a user specific portion and a device specific portion.

In some embodiments, the set of heuristics comprises a first subset of heuristics applicable to the user specific portion, and the first subset of heuristics being configured for executing a determination that the training user interacted with a resource associated with the POI, the resource including at least one of a telephone line associated with the POI, and a website associated with the POI.

In some embodiments, the first subset of heuristics is further configured for executing a determination that the training user interacted with a web resource and the interaction with the web resource included a web search by the training user of the POI in the web resource.

In some embodiments, the web resource is a map service and the web search was in the map service for the POI, the web search having been executed by the training user.

In some embodiments, the set of heuristics comprises a second subset of heuristics applicable to the device specific portion, and the second subset of heuristics is for executing a determination based on the set of timestamped geo-tracked locations that the training user moved to within the pre-determined vicinity of the location of the POI.

In some embodiments, the second subset of heuristics is further configured for executing a determination that the training user was exposed to a targeted message associated with the POI before having moved to within the pre-determined vicinity of the location of the POI.

In some embodiments, the targeted message is an online targeted message.

In some embodiments, the targeted message is an offline targeted message.

In some embodiments, the second subset of heuristics is further configured for executing a determination that the training user moved to within the pre-determined vicinity of the location of the POI in within a pre-determined time limit after having been exposed to the targeted message.

In some embodiments, the pre-determined time limit is less than five hours.

In some embodiments, the pre-determined vicinity is defined by a radius around the location of the POI, the radius being five hundred meters.

In some embodiments, the pre-determined vicinity is defined by a radius around the location of the POI, the radius being one hundred and fifty meters.

In some embodiments, the second subset of heuristics is further configured for executing a determination that the training wireless device connected, via the training communication module, to a local area network (LAN) associated with the POI.

In some embodiments, the timestamp of each geo-tracked location in the sequential set of the geo-tracked locations is indicative of a time that occurred at least a pre-determined time-distance after the time indicated by the timestamp of a geo-tracked location preceding that geo-tracked location.

In some embodiments, the pre-determined time-distance is 75 seconds.

In some embodiments, each geo-tracked location in the sequential set of the geo-tracked locations is no more than a pre-determined distance away from another geo-tracked location in the sequential set of the geo-tracked locations.

In some embodiments, the pre-determined distance is 30 meters.

In some embodiments, the sequential set of the geo-tracked locations includes a first sequential subset of geo-tracked locations and a second sequential subset of geo-tracked locations; a time difference between a last-in-time geo-tracked location of the first sequential subset of geo-tracked locations and a first-in-time geo-tracked location of the second sequential subset of geo-tracked locations does not exceed a pre-determined time difference threshold; each of the first and second sequential subsets of geo-tracked locations has a centroid determined based on the geo-tracked locations of that subset of geo-tracked locations; and a distance between the centroids of the first and second sequential subsets of geo-tracked locations does not exceed a pre-determined centroid-to-centroid distance threshold.

According to another aspect of the present technology, there is provided a method of determining a Place Visit Lift (PVL) metric, the method being executed at a server having a processor and a non-transient memory communicatively coupled to the processor, the non-transient memory storing processor-executable instructions thereon for executing the method.

In some embodiments, the method includes: determining, by the server, a visitors_site parameter, the visitors_site parameter being equal to a number of users that both: a) were exposed to a targeted message directing users to a point of interest (POI), and b) visited the POI after having been exposed to the targeted message; determining, by the server, a bypassers_site parameter, the bypassers_site parameter being equal to a number of users that did not visit the POI after having been exposed to the targeted message; determining, by the server, a visitors_non-site parameter, the visitors_non-site parameter being equal to a number of users that were not exposed to the targeted message but visited the POI; determining, by the server, a bypassers_non-site parameter, the bypassers_non-site parameter being equal to a number of users that were not exposed to the targeted message and did not visit the POI; and determining, by the server, the PVL metric according to the following formula:

$$PVL = \frac{visitors\_site / bypassers\_site}{visitors\_non \text{-} site / bypassers\_non \text{-} site} * 100 \% - 100 \% .$$

In some embodiments, at least one of the parameters is determined using the method of determining a fact of a visit, as described above.

In some embodiments, each of visitors_site parameter, the bypassers_site parameter, the visitors_non-site parameter, and the bypassers_non-site parameter is determined using the method of determining a fact of a visit, as described above.

In some embodiments, the targeted message is an online targeted message.

In some embodiments, the targeted message is an offline targeted message.

According to yet another aspect of the present technology, there is provided a method of determining a conversion rate of a targeted message associated with a POI, the method being executed at a server having a processor and a non-transient memory communicatively coupled to the processor, the non-transient memory storing processor-executable instructions thereon for executing the method.

In some embodiments, the method includes: determining during an in-use phase, by the server, a plurality of users that have been exposed to a targeted message associated with the POI within a first pre-determined time period, each user of the plurality of users using a wireless device having a geo-location module and a wireless device identifier; receiving during the in-use phase, at the server based on the wireless device identifiers of the wireless devices of the plurality of users, a plurality of geo-tracks from the geographical area and determining a plurality of dwell profiles based on the plurality of geo-tracks; inputting, by the server into the MLA as described above as an in-use input, the plurality of dwell profiles; receiving, by the server from the MLA as an in-use output based on the plurality of dwell profiles, a plurality of indications, a given indication of the plurality of indications being associated with a given user of the plurality of users and indicating whether the given user visited the POI within a second pre-determined time period after having been exposed to the targeted message; and determining during the in-use phase, by the server, based on the plurality of indications, a conversion rate parameter indicating the conversion rate of the targeted message, the conversion rate being a percentage of the plurality of users that have visited the POI within the second pre-determined time period after having been exposed to the targeted message.

The examples above are non-limiting.

### DESCRIPTION OF THE DRAWINGS

FIG. 1 depicts a schematic diagram of a system suitable for implementing non-limiting embodiments of the present technology.

FIG. 2 depicts a log containing geo-location coordinates, the log having been generated or hosted by a wireless device of the system of FIG. 1.

FIG. 3 depicts a digital content item database of the system of FIG. 1.

FIG. 4 depicts a user profile database of the system of FIG. 1.

FIG. 5 depicts a non-limiting example of a geographical area with examples of training dwell profiles, POIs in the geographical area, and users in the geographical area, each of the users having at least one wireless device.

FIG. 6 depicts a non-limiting example of a geographical area with examples of in-use dwell profiles, POIs in the geographical area, and users in the geographical area, each of the users having at least one wireless device.

FIG. 7 depicts a logic flow diagram showing a non-limiting embodiment of a method according to the present technology.

FIG. 8 depicts a logic flow diagram showing a non-limiting embodiment of another method according to the present technology.

FIG. 9 depicts a logic flow diagram showing a non-limiting embodiment of yet another method according to the present technology.

### DETAILED DESCRIPTION

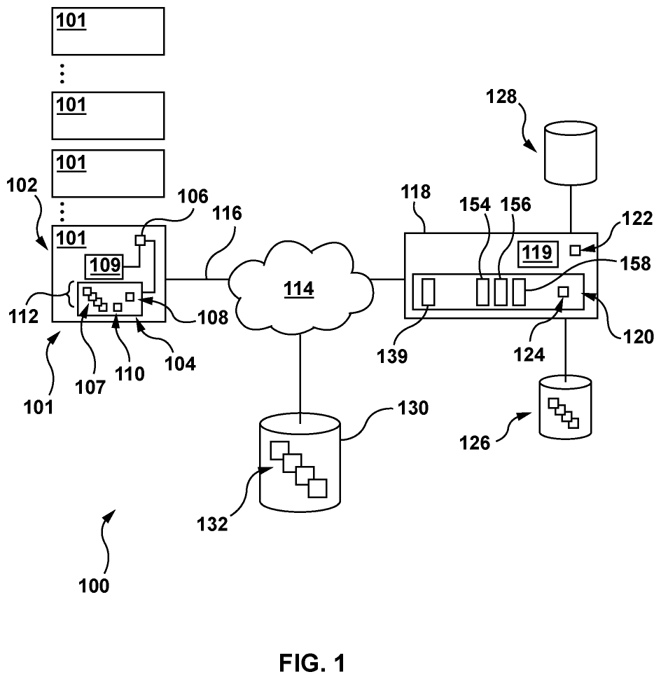

Referring to FIG. 1, there is shown a schematic diagram of a system 100, the system 100 being suitable for implementing non-limiting embodiments of the present technology. It is to be expressly understood that the system 100 is depicted merely as an illustrative implementation of the present technology. Thus, the description thereof that follows is intended to be only a description of illustrative examples of the present technology. This description is not intended to define the scope or set forth the bounds of the present technology.

In some cases, what are believed to be helpful examples of modifications to the system 100 may also be set forth below. This is done merely as an aid to understanding, and, again, not to define the scope or set forth the bounds of the present technology. These modifications are not an exhaustive list, and as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology.

As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope. Furthermore, as an aid to understanding, the following description may describe relatively simplified implementations of the present technology. As persons skilled in the art would understand, various implementations of the present technology may be of greater complexity.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor” may be provided through the use of dedicated hardware as well as hardware capable of executing software in association with appropriate software. When provided by a processor, the functions may be provided by a single dedicated processor, by a single shared processor, or by a plurality of individual processors, some of which may be shared.

In some embodiments of the present technology, a processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

With these fundamentals in place, we will now consider some non-limiting examples to illustrate various implementations of aspects of the present technology.

Referring to FIG. 1, the system 100 has access to a plurality of wireless devices 101. Some of the wireless devices 101 are shown in FIG. 1. The wireless devices 101 are similar to each other at least insofar as being suitable for use with the present technology. Therefore, only a representative one of the wireless devices 101, namely wireless device 102, is described herein in detail. The wireless device 102 is typically a portable wireless device that is associated with a user (not depicted) and, as such, can sometimes be referred to as a “client device”. It should be noted that the fact that the wireless device 102 is associated with the user does not mean to suggest or imply any mode of operation—such as a need to log in, a need to be registered or the like.

In the context of the present specification, unless provided expressly otherwise, a “wireless device” is any portable wireless device having at least one kind of geo-location means for determining its own geo-location and at least having Wi-Fi connectivity capability to connect to local area networks (LANs) and/or other devices. Some non-limiting examples of wireless devices include Wi-Fi enabled and Global Positioning System (GPS) enabled smartphones and tablets that are typically carried around by their users wherever they go. It should be noted that a device acting as a wireless device in the present context is not precluded from acting as a server to other wireless devices. The use of the expression “a wireless device” does not preclude multiple client devices being used in receiving/sending, carrying out or causing to be carried out any task or request, or the consequences of any task or request, or steps of any method described herein.

The wireless device 102 comprises a permanent storage 104 storing processor-executable instructions therein, a processor 106 communicatively coupled to the permanent storage 104, and a local area communication module 109 communicatively coupled to the processor 106. The permanent storage 104 may encompass one or more storage media and provides a place to store computer-executable instructions executable by a processor 106. By way of an example, the permanent storage 104 may be implemented as a computer-readable storage medium including Read-Only Memory (ROM), hard disk drives (HDDs), solid-state drives (SSDs), and flash-memory cards. The local area communication module 109 in the present embodiment includes a Wi-Fi module capable of connecting to a local area network (LAN) that may be shared via a Wi-Fi access point such as a wireless router. In some embodiments, the local area communication module 109 also includes a Bluetooth™ module for Bluetooth connectivity.

The wireless device 102 further comprises hardware and/or software and/or firmware (or a combination thereof) to execute a plurality of applications 107, including a navigation application 108 stored at least in part in the permanent storage 104. One purpose of the navigation application 108 is to enable the user to navigate from one location to another location. The manner in which the navigation application 108 is implemented is known in the art and will not be described herein. For example, the navigation application 108 may be one of Yandex.Maps™, Yandex.Navigator™, or other commercial or proprietary map application.

The wireless device 102 also has access to a GPS receiver configured to receive GPS satellite signals and determine the geo-location of the wireless device 102, or other means of determining the geo-location of the wireless device 102 at given times and/or time intervals. In the present embodiment, the wireless device 102 includes the GPS receiver on-board. In at least some embodiments, the wireless device 102 does not need to be connected to the Internet, nor be executing the navigation application 108, to receive the GPS satellite signals, and as such the wireless device 102 may be configured to track the movement of user in the form of geo-locations that may be recorded in terms of latitude and longitude irrespective of the availability of the Internet connection. In the present embodiment, the wireless device 102 determines its GPS coordinates at a given frequency which depends on each particular embodiment of the wireless device 102 and its operating system for example, and records them in a log 110.

In some embodiments, the wireless device 102 stores the log 110 on-board, in the permanent storage 104. In some embodiments, the log 110 is stored remote to the wireless device 102, such as at a remote server. In some embodiments, the wireless device 102 makes its geo-location available to one or more remote servers. In some embodiments, the wireless device 102 makes its geo-location available to one or more remote servers in or near real-time.

In some non-limiting embodiments, the log 110 stores the geo-locations of the wireless device 102 as timestamped geo-location coordinates of the wireless device 102 that have been collected or provided by the wireless device 102 over time. In some embodiments, the wireless device 102 collects and in some cases hosts the log 110 and/or its timestamped GPS coordinates, such as via a combination of the applications 107 and/or via the operating system of the wireless device 102 without any particular application stored on the wireless device 102 being opened by a user thereof.

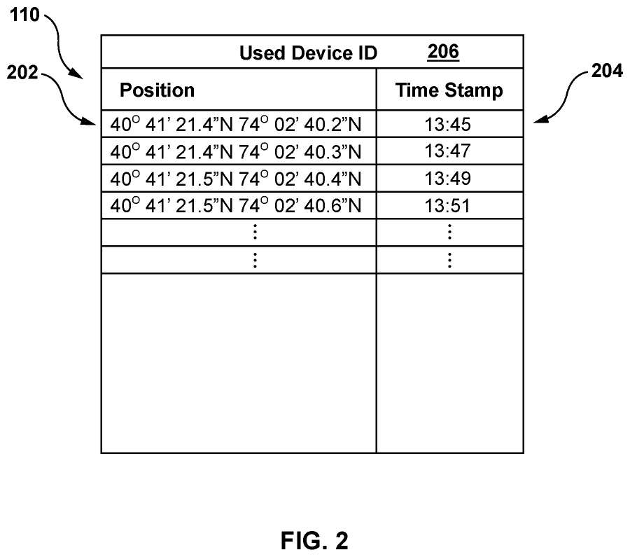

With reference to FIG. 2, a non-limiting embodiment of the log 110 is illustrated. The manner and format in which the log 110 is populated and stored is not limited. As an example, the wireless device 102 may be configured to receive the GPS satellite signals at predetermined time intervals, and convert the GPS satellite signals into timestamped geo-location coordinates. In some embodiments, the wireless device 102 comprises and/or uses cell-tower triangulation or other geo-location determining means to obtain its geo-locations, either instead of or in addition to using a GPS system.

In the example shown in FIG. 2, the log 110 comprises a first geo-location coordinate 202 which corresponds to, for the sake of a non-limiting example, a MacDonald's™ 500 in a given geographical area 136. The first geo-location coordinate 202 is associated with a first timestamp 204. The first timestamp 204 corresponds to the time at which the wireless device 102 was at the first geo-location coordinate 202. The log 110 further comprises additional geo-location coordinates and associated time stamps (not separately numbered). For example, based on the time stamps and geo-location coordinates within the log 110, it could be understood that the wireless device 102 has moved 0.5 seconds north and 0.4 seconds west within 6 minutes. Only four geo-locations are illustrated in the log 110, to maintain clarity. The log 110 may comprise more or fewer geo-locations/coordinates.

In some embodiments, the wireless device 102 is configured to assign a user device ID 206 to the log 110. For example, the user device ID 206 may be a MAC address of the wireless device 102 or a component thereof, and/or may be an indication of a user name (such as an email address) associated with the user if the wireless device 102 requires the user signing-in, and so on. In another example, the user device ID 206 may correspond to a proprietary ID number assigned by, for example, the navigation application 108 and/or other service application(s) 112 (described below). The user device ID 206 is thus one example of a wireless device identifier of the wireless device 102.

Referring back to FIG. 1, the wireless device 102 comprises hardware and/or software and/or firmware (or a combination thereof) to execute one or more service applications 112. In some embodiments, the one or more service applications 112 comprise at least one service application (not numbered) that is operated by the same entity that has provided the afore-described navigation application 108. For example, if the navigation application 108 is Yandex.Navigator, the one or more service applications 112 may include a web browser application Yandex.Browser™, a news application Yandex.News™, a market application Yandex.Market™, and the like. Needless to say, the one or more service applications 112 may also include service applications that are not operated by the same entity that has provided the afore-mentioned navigation application 108, and may comprise for example, social media applications such as Vkontakte™, and music streaming application such as Spotify™.

In some embodiments the activities of the user executed via the wireless device 102 are collected by one or more servers, and are used to build a profile of the user, or simply a user profile, associated with the user and/or the user's wireless device(s) 102. In some embodiments, the user profile comprises a user specific portion comprising information related to the user and a device specific portion comprising information related to the user's wireless device(s) 102. In some embodiments, the one or more service applications 112 that are operated by the same entity as the navigation application 108 are configured to report and/or store user activities and/or geo-locations with an accompanying indication of the user device ID 206 or other means for allowing subsequent identification of the user's activity/geo-location history with the user's wireless device(s) 102 via which the user performed the actions constituting the user's activity history.

The wireless device 102 comprises a communication interface (not depicted) for enabling two-way communication with a communication network 114 via a communication link 116. In some non-limiting embodiments of the present technology, the communication network 114 can be implemented as the Internet. In other embodiments of the present technology, the communication network 114 can be implemented differently, such as any wide-area communication network, local area communications network, a private communications network and the like. In some embodiments, the communication interface includes and/or operates with the local area communication module 109 of the wireless device 102.

How the communication link 116 is implemented is not particularly limited and depends on how the wireless device 102 is implemented. Merely as an example and not as a limitation, in those embodiments of the present technology where the wireless device 102 is implemented as a wireless device (such as a smart phone), the communication link 116 can be implemented as a wireless communication link (such as, but not limited to, a 3G communications network link, a 4G communications network link, a Wireless Fidelity, or WiFi®, for short, Bluetooth®, or the like) or wired (such as an Ethernet based connection).

It should be expressly understood that implementations for the wireless device 102, the communication link 116 and the communication network 114 are provided for illustration purposes only. As such, those skilled in the art will easily appreciate other specific implementational details for the wireless device 102, the communication link 116, and the communication network 114. As such, by no means the examples provided hereinabove are meant to limit the scope of the present technology.

Still referring to FIG. 1, the system 100 further includes a server 118 coupled to the communication network 114. The server 118 can be implemented as a computer server. In an example of an embodiment of the present technology, the server 118 can be implemented as a Dell™ PowerEdge™ Server running the Microsoft™ Windows Server™ operating system. Needless to say, the server 118 can be implemented in any other suitable hardware and/or software and/or firmware or a combination thereof. In the depicted non-limiting embodiment of the present technology, the server 118 is a single server. In alternative non-limiting embodiments of the present technology, the functionality of the server 118 may be distributed and may be implemented via multiple servers.

The server 118 comprises a communication interface 119 structured and configured to communicate with various entities (such as the wireless devices 101, and other devices potentially coupled to the communication network 114) via the communication network 114. The server 118 comprises a non-transient memory 120 which comprises one or more storage media and generally provides a place to store computer-executable program instructions executable by a processor 122. By way of example, the memory 120 may be implemented as a tangible computer-readable storage medium including Read-Only Memory (ROM) and/or Random-Access Memory (RAM). The memory 120 may also include one or more storage devices in the form of, by way of example, hard disk drives (HDDs), solid-state drives (SSDs), and flash-memory cards.

In some embodiments, the server 118 can be operated by the same entity that has provided the afore-described navigation application 108. For example, if the navigation application 108 is a Yandex.Navigator, the server 118 can be operated by Yandex LLC of Lev Tolstoy Street, No. 16, Moscow, 119021, Russia. In alternative embodiments, the server 118 can be operated by an entity different from the one that has provided the aforementioned navigation application 108. It is noted that while the server 118 is described herein below in some non-limiting embodiments as being configured with a particular set of modules providing various combinations of functions, in alternative non-limiting embodiments the server 118 could be configured with a different set of modules and/or in at least partially a distributed manner, so long as the functionality described in this document is provided.

### Digital Content Item Database

To that end, the server 118 is communicatively coupled to a digital content item database 126. In alternative embodiments, the digital content item database 126 may be communicatively coupled to the server 118 via the communication network 114. Although the digital content item database 126 is illustrated schematically herein as a single entity, it is contemplated that the digital content item database 126 may be configured in a distributed manner.

The digital content item database 126 is populated with a plurality of digital content items (not separately numbered). The nature of each of the plurality of digital content item is not particularly limited. Broadly speaking, a digital content item may correspond to a targeted message relating to one or more points of interest (POI), and comprising one or more sentences, images, videos, etc.

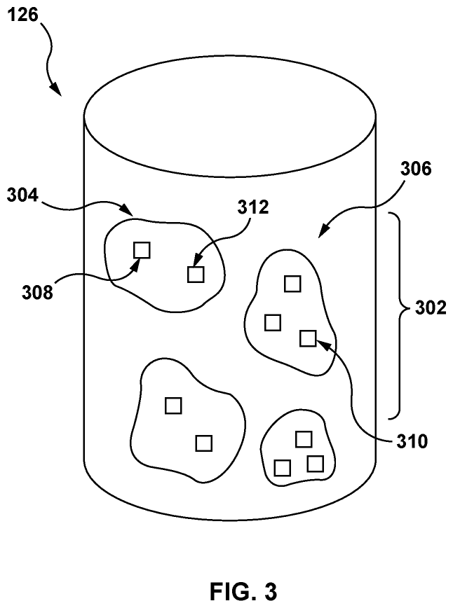

With reference to FIG. 3, a non-limiting embodiment of the digital content item database 126 populated with the plurality of digital content item is illustrated.

The manner in which the digital content item database 126 is populated is not limited. Just as an example the digital content item database 126 may receive the digital content items from one or more content providers.

In at least some non-limiting embodiments of the present technology, the digital content item database 126 can store the plurality of digital content items clustered into one or more topics. As such, the digital content item database 126 can be configured to execute a topic clustering routine (not depicted). The manner in which the plurality of digital content items are clustered into one or more topics or events is not limited, and may for example, be done using conventional clustering techniques, such as topic modelling or key word based approaches.

The plurality of digital content items is clustered into one or more topic clusters 302. For example, the digital content item database 126 stores a first topic cluster 304, a second topic cluster 306, a third topic cluster (not numbered) and a fourth topic cluster (not numbered). The first topic cluster 304 includes a first digital content item 308 and a second digital content item 312, and the second topic cluster 306 includes a third digital content item 310.

In some non-limiting embodiments of the present technology, the digital content item database 126 comprises additional information in respect to each of the plurality of digital content items, such as the duration of the digital content item, a minimum bidding price, target parameters selected by a source of the digital content item, indication of the digital content item being static or dynamic, and the like.

### POI Databases

With reference to FIG. 1, the server 118 may be further in communication with a remote Point of Interest (POI) profile database 130. In some non-limiting embodiments of the present technology, the POI profile database 130 may be communicatively coupled to the server 118 via a local connection or other direct link. Although the POI profile database 130 is illustrated schematically herein as a single entity, it is contemplated that the POI profile database 130 may be implemented in a distributed manner.

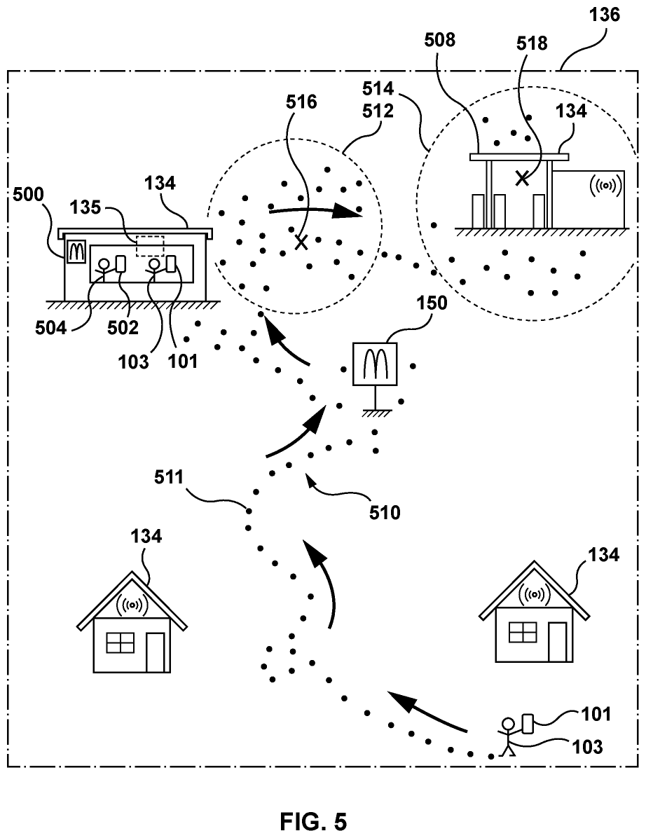

In some non-limiting embodiments, the POI profile database 130 stores a plurality of POI profiles 132 of POIs 134 located in a given geographical area 136. A non-limiting example of a geographical area 136 and POIs 134 located therein are shown schematically in FIG. 5. The geographical area 136 may be for example, a given region in a country, a given city, a particular neighborhood of a city, a particular street, and so on. The POIs 134 may be, for example, businesses, services, landmarks, and so on. Some particular examples of POIs 134, as shown in FIG. 5, may include a MacDonald's™ 500 and a Petro-Canada™ gas station 508.

The POI profile 132 of a given POI 134 may include, for example, hours of operation of the given POI 134, a category of the given POI 134, a geo-location of the given POI 134, an address of the given POI 134, a rating of the given POI 134, and so on.

### User Profile Database

With reference to FIG. 1, the server 118 is further in communication with a user profile database 128 that, inter alia, stores the user profiles 129 (described above) of the users of the wireless devices 101. In alternative non-limiting embodiments of the present technology, the user profile database 128 may be communicatively coupled to the server 118 via the communication network 114. Although the user profile database 128 is illustrated schematically herein as a single entity, it is contemplated that the user profile database 128 may be configured in a distributed or any other manner.

The user profile database 128 is a repository of the user profiles 129, each one of which is associated with one or more of the wireless devices 101. How the one or more user profiles 129 are stored is not limited, and may for example be a set of vectors representing the interests of a given user of one or more of the wireless devices 101.

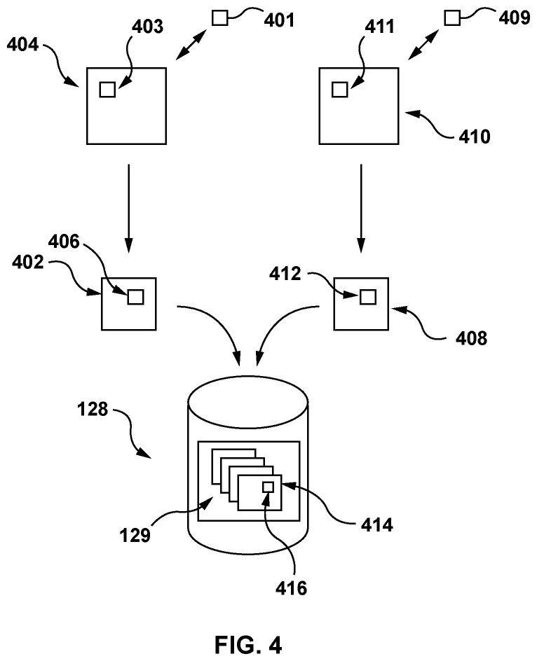

With reference to FIG. 4, a schematic illustration of the aggregation of different user profiles associated with the user of the wireless device 102, the wireless device 102 being an example one of the wireless devices 101, is depicted.

A first profile 402 is received from a first service server 404. For example, the first service server 404 may be associated with a first service application 401 that corresponds to Yandex.Browser, which is operated by the same entity providing the aforementioned navigation application 108 on the wireless device 102. The first profile 402 may be generated by the first service server 404 based on for example the browsing logs 403 associated with the wireless device 102.

The first profile 402 is associated with a first unique ID 406, which is a proprietary user ID, associated with the wireless device 102. More particularly, and recalling that the first service application 401 is operated by the same entity providing the aforementioned navigation application 108 on the wireless device 102, the first unique ID 406 of the first profile 402 corresponds to the user device ID 206 of the wireless device 102.

A second profile 408 for the user of the wireless device 102 is received from a second service server 410. For example, the second service server 410 may be associated with a second service application 409 on the wireless device 102 that corresponds to Yandex.Market, which is operated by the same entity providing the aforementioned navigation application 108. The second profile 408 may be generated by the second service server 410 based for example on search logs 411 associated with searches executed by the user of the wireless device 102 via Yandex.Market on the wireless device 102.

The second profile 408 is also associated with a second unique ID 412. Given that Yandex.Market requires an email address to be provided by the user to access the digital service, the second unique ID 412 comprises both the email address of the user as well as the proprietary user ID, which corresponds to the user device ID 206.

In some non-limiting embodiments, the user profile database 128 is configured to execute a profile aggregation routine (not depicted). The profile aggregation routine is configured to determine if the first profile 402 and the second profile 408 correspond to the same user. For example, the profile aggregation routine may be configured to determine if the first unique ID 406 corresponds, at least partially, to the second unique ID 412.

If it is determined that the first unique ID 406 corresponds at least partially to the second unique ID 412, the profile aggregation routine is configured to aggregate the first profile 402 and the second profile 408 to generate an aggregated profile 414.

As a result of the execution of the profile aggregation routine, the user profile database 128 stores the aggregated profile 414 together with a third unique ID 416 (which corresponds to the user device ID 206 and the email address).

On the other hand, if the profile aggregation routine determines that the first unique ID 406 does not correspond even partially to the second unique ID 412, the first profile 402 and the second profile 408 are considered to be associated with different users. Consequently the user profile database 128 stores the first profile 402 (and the first unique ID 406) and the second profile 408 (and the second unique ID 412) separately.

Needless to say, although only two user profiles (the first profile 402 and the second profile 408) are illustrated to generate the aggregated profile 414, it should be understood that the aggregated profile 414 may be generated based on more than two user profiles for a given wireless device 101.

Moreover, although the aggregated profile 414 has been generated based solely on service applications that are operated by the same entity, it is not limited as such. Given that the second profile 408 includes the email address associated with the user, it is possible to further aggregate the user's profile with a third profile (not shown) that is received from a different entity, provided that the third profile is also associated with a third unique ID that corresponds to the same email address.

In summary, the user profile database 128 stores a plurality of user profiles 129, with each of the user profiles 129 being associated with at least one of the wireless devices 101. In some non-limiting embodiments of the present technology, the user profiles 129 include additional information about the users to which they belong.

Some non-limiting examples of such additional information are the users' browsing histories in various application, the user's preferences indicated by the user for particular products, the user's preferences inferred by one or more third parties, and so on. Other non-limiting examples are the users' purchase histories.

In some embodiments, the user's preferences include indications of the user's preferences for particular identified points of interest (POIs) 134 in the given geographical area 136 (FIG. 5) and/or for particular identified kinds of POIs 134 in the geographical area 136. As will be described below in detail, at least some non-limiting embdoiments of the present technology uses such user profile data for improving accuracy of determinations of facts of visits by the users to particular ones of the POIs 134 in the geographical area 136.

### Dwell Profile Module

Referring back to FIG. 1, in some non-limiting embodiments, the server 118 stores in its memory 120 and executes a dwell profile module 139. The dwell profile module 139 retrieves timestamped geo-locations of the wireless devices 101 to which the server 118 has access, over a period of time.

As described in more detail below, the dwell profile module 139 analyzes timestamped geo-tracks received from various users' wireless devices 101 to generate indications of the users having been in a pre-defined vicinity of various different locations in the geographical area 136 over a pre-determined timeframe. Each such indication, is further referred to as “a dwell profile”. Thus, a given dwell profile of a given user is indicative of the user having been in a pre-defined vicinity of a given location over a pre-determined timeframe.

Two example dwell profiles 512 and 514 are shown in FIG. 5 for illustration. As shown, the dwell profile 512 is indicative of the associated user having spent some time at or near a MacDonald's™ 500 in the geographical area 136. The dwell profile 514 is separate from the dwell profile 512 and is indicative of the associated user having later spent some time at or near a gas station 508 in the geographical area 136.

For generating dwell profiles, the dwell profile module 139 retrieves timestamped geo-tracks containing sequential timestamped geo-locations of many different wireless devices 101 in a given geographical area 136. FIG. 5 depicts an example geo-track 510 of a given wireless device 101 of a given user 103 that will be used to illustrate the present technology. As shown, the geo-track 510 includes a plurality of sequential time-stamped locations 511 of the wireless device 101, and therefore of the user, in the geographical area 136. The sequential time-stamped locations 511 represent the movement of the given user 103 in the geographical area 136. To maintain clarity of FIG. 5, only one of the sequential time-stamped locations 511 has been labeled.

In some embodiments, the dwell profile module 139 retrieves and updates geo-tracks continuously from each given wireless device 101 as the timestamped geo-location data becomes available. The data collection frequency may be different for different wireless devices 101, and may be a function of the particular embodiment of each given wireless device 101 and/or each given wireless device's 101 operating system and/or configuration. As a non-limiting example, a given wireless device 101 may report its geo-location at a time frequency of ⅓ hertz, or once every three seconds.

The dwell profile module 139 stores the timestamped geo-tracks of each given wireless device 101 with the associated unique ID of the given wireless device 101, in a user geo-location database 141. In some embodiments, the dwell profile module 139 further configures the user geo-location database 141 by associating therein the geo-location data of each given wireless device 101 with the corresponding user profile 129 and/or the user device ID 206 or other corresponding unique identifier.

The dwell profile module 139 then analyzes the geo-tracks 510 the geo-tracks in the user geo-location database 141 to generate dwell profiles. A particular embodiment of a method of generating a dwell profile, as executed by the dwell profile module 139, is described next.

The dwell profile module 139 first groups the timestamped geo-locations of each geo-track 510 into a plurality of predefined first groups of sequential geo-locations, according to the following rules.

In each such group, each given geo-location has at least one other neighboring geo-location that is both: a) no more than a pre-defined distance away from the given geo-location; and b) has a timestamp that indicates a time that occurred at least a pre-defined time period after the time indicated by the timestamp of the given geo-location. In some embodiments, the pre-defined distance is 30 meters and the pre-defined time period is 75 seconds. It is contemplated that different magnitudes of these constants could be used depending on, for example, each particular geographical area and POI density in that particular geographical area. It is contemplated that different magnitudes of these constants could be used depending on, for example, the geo-location determination accuracy of each given wireless device 101 as may be reported by the given wireless device 101.

Next, the dwell profile module 139 attempts to combine at least some of the first groups of sequential geo-locations to generate one or more second groups of sequential geo-locations, according to the following rules. One first given group is combined with another one first given group to form a second group if both of the following conditions are met: 1) the time difference (delta-T) between the timewise-last geo-location in the one first given group and the timewise-first geo-location in the other one first given group is below a pre-determined time difference threshold; and 2) a centroid-to-centroid distance between a centroid of the one first given group an a centroid of the other one first given group does not exceed a centroid-to-centroid distance threshold.

The delta-T parameter is calculated by subtracting from the timestamp of the timewise-first geo-location, the timestamp of the timewise-last geo-location. The centroid of any given group is calculated by assigning a weight to each given geo-location in that given group as being equal to a time that the associated user spent at that given geo-location. A center of mass is then calculated based on all time-weighted geo-locations in then given group. The so-calculated time-weighted center of mass is used as the centroid. In other words, the resulting centroid represents a single geo-location at which the user is deemed to have spent all of the time associated with the given group. In some embodiments, the pre-determined time difference threshold is equal to 180 seconds, and the centroid-to-centroid distance threshold is equal to 60 meters. Understandably these parameters are non-limiting examples, and could be different depending on each particular application of the present technology.

The dwell profile module 139 iterates according to the steps above through each pair of groups in the first groups of sequential geo-locations and combines each pair that meets the above requirements into a single group. The dwell profile module 139 also attempts to further combine pairs of the resulting groups according to the same conditions as set out above. When the dwell profile module 139 identifies a group that cannot be combined any further because one or more of the above conditions are not met, the dwell profile module 139 labels that group as a distinct dwell profile.

Thus, each resulting dwell profile 512, 514 includes both a plurality of sequential timestamped geo-locations, and a single centroid with an associated total time that the user is deemed to have spent at the single centroid. FIG. 5 shows the centroid 516 of the dwell profile 512 and centroid 518 of the dwell profile 514 of the user 103. Understandably, the user 103 could have fewer or more dwell profiles 512, 514 associated with her.

As described in detail next, a first subset of the dwell profiles generated by the dwell profile module 139 for users in the geographical area 136 is used during a training phase to train a Machine Learning Algorithm (MLA) 158. The training, described next, is to enable the MLA 158 to determine facts of visits by users to POIs 134 in the geographical area 136.

### Training Dataset Generating Module

The server 118 stores in its memory 120 and executes a training dataset generating module 154. In summary, and as described in detail below, the training dataset generating module 154 generates the training dataset that is then fed to a Machine Learning Algorithm (MLA) 158 to train the MLA 158 to determine a fact of a visit to a POI 134 based on a given dwell profile of a given user.

In summary, to generate the training dataset, the training dataset generating module 154 retrieves a plurality of dwell profiles of a plurality of users in the geographical area 136, as determined by the dwell profile module 139. These dwell profiles are referred to as training dwell profiles. Similarly, the users associated with the training dwell profiles are referred to as training users.

The training dataset generating module 154 determines, using a set of heuristics, whether each given training dwell profile of each given training user corresponds to the associated training user visiting a given POI. The training dataset generating module 154 then labels each given training dwell profile with a corresponding training label that is indicative of a result of the determination of a visit using the heuristics. The training dataset generating module 154 thereby creates a training object of the training dataset. The training dataset generating module 154 repeats the heuristics process for each given training dwell profile and thereby creates all of the training objects of the training dataset.

More particularly, the training dataset generating module 154 first retrieves the identities of the wireless devices 101 associated with the geographical area 136. Based on the identities of the wireless devices 101, the training dataset generating module 154 retrieves a plurality of training dwell profiles of a plurality of wireless devices 101, further referred to as training wireless devices 101.

For each given training dwell profile of a given training wireless device 101, the training dataset generating module 154 determines which of the POIs 134, if any, are located within a pre-determined vicinity of the centroid of that training dwell profile. In some non-limiting embodiments, the pre-determined vicinity is defined by a radius of 60 meters centered about the centroid of the corresponding training dwell profile. In other non-limiting embodiments, the radius is different. It is contemplated that the radius could be pre-determined based on an accuracy of each given training wireless device 101. It is contemplated that the radius could be pre-determined for each given training wireless device 101, both in the training phase and later in the in-use phase, based on the geo-locational accuracy of that given wireless device 101.

Where the training dataset generating module 154 determines that none of the POIs 134 are located within the pre-determined vicinity of the centroid, the training dataset generating module 154 labels the training dwell profile with a label indicating that none of the POIs 134 is being visited.

On the other hand, where the training dataset generating module 154 determines that at least one of the POIs 134 are located within the pre-determined vicinity, the training dataset generating module 154 applies the set of heuristics, which are described in the next section below, to determine whether or not one of the POIs 134 is being visited by the training user of the training dwell profile at the time corresponding to the training dwell profile. The set of heuristics returns either a positive or a negative determination. The training dataset generating module 154 then labels the training dwell profile with a label indicating the result of the determination. Such labels may be referred to as training labels.

In some non-limiting embodiments, a given training label may include a name and/or other identification, such as an address, of the POI 134 being visited and/or a probability of the POI 134 being visited. In some non-limiting embodiments, a given training label may further include names of other POIs 134 in the pre-determined vicinity and corresponding probabilities of those other POIs 134 being visited.

As an example, referring to FIG. 5, let's assume that the set of heuristics applied to the training dwell profile 512 returns a negative determination, the negative determination being that the user 103 was not visiting the MacDonald's 500 at the time associated with the training dwell profile 512. In this case, the training dataset generating module 154 labels the training dwell profile 512 with a training label indicative of the negative determination. If for another user's dwell profile the set of heuristics returns a positive determination regarding visiting the MacDonald's 500, the training dataset generating module 154 labels that other training dwell profile with a training label indicative of the positive determination.

Also, let's say that the set of heuristics applied to the training dwell profile 514 returns a positive determination, the positive determination being that the user 103 was visiting the gas station 508 at the time associated with the training dwell profile 514. Accordingly, the training dataset generating module 154 labels the training dwell profile 514 with a training label indicative of the positive determination. Understandably, while only two POIs 134 and two training dwell profiles 512, 514 are used for illustration, the training dataset generating module 154 labels many different training dwell profiles of many different training users, with respect to each of the POIs 134 in the geographical area. The end result is a labeled training dataset that is used to train the MLA 158.

The set of heuristics is described next, in detail.

### Set of Heuristics

To enable the abovementioned determinations of facts and times of visits, the set of heuristics comprises a first subset of heuristics applicable to the user specific portion of each given user profile 129 of the associated user. In some embodiments, the first subset of heuristics is configured for executing a determination that the relevant user interacted with a resource associated with a given POI 134. The resource associated with a given POI 134, in some non-limiting embodiments, may include at least one of a telephone line associated with the POI 134, and a website associated with the POI 134. The website is one example of a web resource associated with the POI 134. Other examples of web resources are a map service. For the MacDonald's 500 example above, the telephone line may be a telephone line of the particular location of the MacDonald's 500, the website may be the MacDonald's 500 general website, and the map service may be the navigation application 108 of the wireless device 101 of the user 103.

In some non-limiting embodiments, the set of heuristics is further configured for executing determinations of when a given user of a given one of the wireless devices 101 interacted with a web resource of a given POI 134, and when the interaction included the user executing a web search associated with the POI 134. In the example of the MacDonald's 500, the first subset of heuristics may determine that the user 103 executed a search for the location of the MacDonald's 500 via the navigation application 108 of the wireless device 101 and that the user 103 subsequently arrived in the pre-defined vicinity of the location of the MacDonald's 500 based on the centroid 516 of the relevant dwell profile 512.

In the above example of the gas station 508, the first subset of heuristics may determine that the user 103 searched for a product, such as an energy drink, via a search engine executing on the wireless device 101, that the search engine returned an indication that the product is available at the gas station 508, and that the user 103 subsequently arrived in the pre-defined vicinity of the location of the gas station 508 based on the centroid 518 of the relevant dwell profile 514. It is contemplated that the first subset of heuristics may render its determinations of visits further based on other combinations of satisfied conditions and indicators.

As an example, referring to FIG. 5, let's assume that both the MacDonald's 500 and the gas station 508 are within the pre-defined vicinity of the centroid 516 of the training dwell profile 512 and are approximately equidistant from the centroid 516. Also, let's assume that some factors determined by the first subset of heuristics described above suggest that the user is visiting the MacDonald's 500 while other factors determined by the first subset of heuristics described above suggest that the user is visiting the gas station 508.

For improving an accuracy of the determination of the set of heuristics in at least some such cases, that is cases with at least some conflicting heuristics factors/features, in some embodiments, the first subset of heuristics is further configured to analyze the user profile 129 of each given user for indicators that may distinguish the user visiting a particular POI 134 in the pre-determined vicinity of a given dwell profile, versus another POI 134 in the pre-determined vicinity.

For example, by applying the first subset of heuristics to inspect the user profile 129, the training dataset generating module 154 may further determine based on the user profile 129 that the user 103 has regularly purchased one or more products from other MacDonald's chain restaurant locations over the past month. The training dataset generating module 154 may further determine that the user 103 contains no indicators of any interactions with any gas stations. According to these additional factors, the training dataset generating module 154 may therefore determine that the user 103 is in fact visiting the MacDonald's 500 and not the gas station 508.

In some non-limiting embodiments, the set of heuristics may further comprise a second subset of heuristics applicable to the device specific portion of the user profile 129 associated with each given wireless device 101 of each given user. The second subset of heuristics may be applicable to the timestamped geo-tracked locations leading up to each dwell profile, and in some cases also to the timestamped geo-tracked locations of each dwell profile. More particularly, a module of the server 118 may apply the second subset of heuristics to these timestamped geo-tracked locations of a given wireless device 101 and thereby execute a determination that the user of the given wireless device 101 moved to and remained for at least a given pre-determined period of time within the pre-determined vicinity of the location of a given POI 134.

In the case of the user's 103 visit to the gas station 508, the training dataset generating module 154 may for example execute a determination that the user 103 of the wireless device 101 moved to within, and remained within, the pre-determined vicinity of the location of the gas station 508 during the times associated with the training dwell profile 512.

Further, in some non-limiting embodiments, the second subset of heuristics is configured for executing a determination that a given user was exposed to a targeted message associated with a given one of the POIs 134 before having moved to within the pre-determined vicinity of the location of the given one of the POI 134. In some non-limiting embodiments, the targeted message may be an online message. In the example of the gas station 508, an online targeted message may be an indication that a deal is available for one of the products offered at the gas station 508, the indication of the deal having been delivered to the wireless device 101 of the user 103.

In some non-limiting embodiments, the targeted message may be an offline message. In the example of the MacDonald's 500, an offline message may be an indication that the deal is available for one of the products offered at the MacDonald's 500, the indication of the deal having been delivered to the attention of the user 103 via a billboard 150 (FIG. 5) located in the geographic area 136.

In some non-limiting embodiments, the second subset of heuristics is further configured for executing a determination that a given user moved to within the pre-determined vicinity of the location of a given POI 134 within a pre-determined time limit after having been exposed to a targeted message associated with the given POI 134. As an example, the pre-determined time limit programmed into the second subset of heuristics may be five hours and the pre-determined vicinity may be fifty meters away from the location of a given POI 134.

As an example, the second subset of heuristics may determine that a targeted message, such as an advertisement for a food product available at the MacDonald's 500 was delivered to the wireless device 101 of the user 103 at a time that occurred before a given dwell profile of that wireless device 101 for which a heuristics determination of a visit is to be executed. The second subset of heuristics may further determine that the user 103, within 30 minutes of being exposed to the advertisement, moved to within a 150 meters of the MacDonald's 500 and the time of visiting this pre-defined vicinity corresponds to a time associated with the dwell profile being analyzed according to the second subset of heuristics. Accordingly, based on this combination of factors, the second subset of heuristics may render a determination that the user 103 visited the MacDonald's 500 at a time associated with the dwell profile.

In some such non-limiting embodiments, the facts of exposure and associated times of exposure of identified users to a given one or more identified targeted messages, including online targeted messages and offline targeted messages, may be determined by the server 118 using the technology described in a co-owned U.S. Patent Application entitled “METHOD AND SYSTEM FOR PROVIDING A RECOMMENDED DIGITAL CONTENT ITEM” and bearing an attorney docket number 40703-128, filed concurrently with the present application by the same applicant, and incorporated herein by reference in its entirety. It is contemplated that other methods of determining exposure times of users to targeted messages could also be used.

In some non-limiting embodiments, the second subset of heuristics is further configured for executing a determination that a given wireless device 101 connected, via the local area communication module 109 thereof, to a LAN 135 associated with the location of a given POI 134 and/or with the given POI 134 itself. In an example of the gas station 508 being visited by the user 103, the second subset of heuristics may determine that after arriving within the 150 meters of the gas station 508, the user 103 connected to the LAN 135 of the gas station 508 via her wireless device 101.

Based on these factors, the training dataset generating module 154 may render a determination that the user 103 visited the gas station 508 at a time associated with the corresponding dwell profile being analyzed according to the second subset of heuristics.

In summary, the heuristics, including the first and second subsets thereof described above, enable the training dataset generating module 154 to determine and generate a training label for each training dwell profile, the training label being indicative of whether or not that training dwell profile corresponds to a fact and a time of a visit by the training user associated with the training dwell profile to an identified one of the POIs 134. The training dwell profiles and their associated training labels generated by the training dataset generating module 154 form part of the training dataset that is then fed to the MLA 158, as described next.

### MLA Training Module

The server 118 further stores in its memory 120 an MLA training module 156 that feeds the training dataset generated by the training dataset generating module 154 to the MLA 158, the MLA 158 being a neural network type MLA, or a Gradient Boosting type MLA for example.

More particularly, in the training phase, the MLA training module 156 may input into the MLA 158 each given training dwell profile and may designate the training label corresponding to the training dwell profile as the corresponding output of the MLA 158. In this sense, each given training dwell profile provides a training set of local area communication features for the MLA 158.

In some embodiments, the MLA 158 is trained to output a name or other identifier of a given POI 134 being visited for positive determinations, and an indication that none of the POIs 134 is being visited for negative determinations.

In some embodiments, the MLA 158 may be trained to output a ranked list of identified POIs 134, in which list each of the POIs 134 is provided with an indication of a probability, the probability indicating that a corresponding user is visiting that particular one of the POIs 134. The list may be ranked from a most-probably visited one of the POIs 134 to a least-probably visited one of the POIs 134.

Once the MLA 158 is sufficiently trained and with the server 118 and system 100 structure described above, various methods can now be practiced. These methods are described next.

### Method of Determining a Visit to a POI

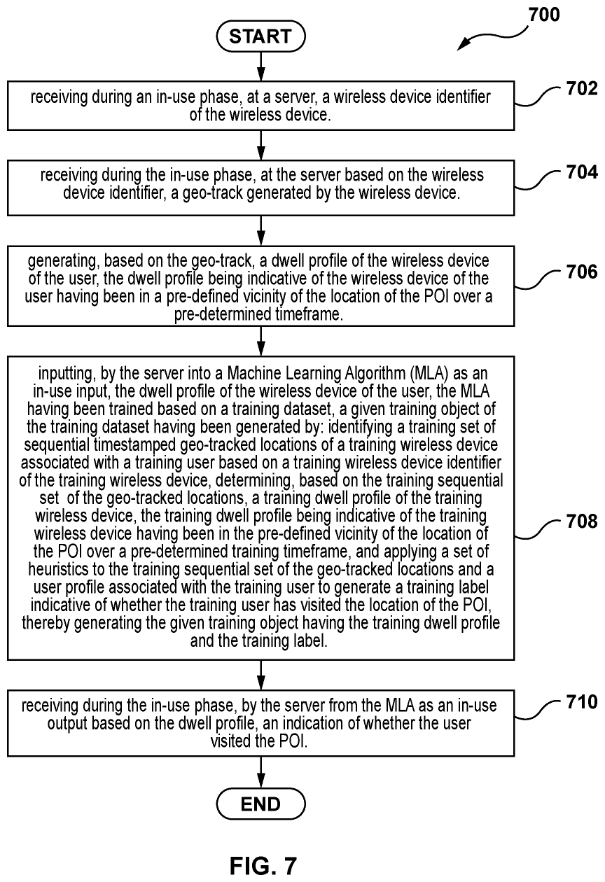

Now referring to FIG. 7, in some non-limiting embodiments of the present technology, there is provided a method 700 of determining a fact of a visit of a user to a POI 134, the user using a wireless device having a geo-location module and a wireless device identifier, the POI 134 being in a location.

In some non-limiting embodiments, the method 700 is executed at the server 118 having a processor 122 and a non-transient memory 120 communicatively coupled to the processor 122, the non-transient memory 120 storing processor-executable instructions thereon for executing the method 700. One example of a server suitable for executing the method 700 is the server 118, as described above. Accordingly, for simplicity and not to be limiting, the method 700 will be described with regard to the server 118.

Step 702—receiving during an in-use phase, at the server, a wireless device identifier of the wireless device.

In one embodiment, the method 700 starts at step 702, which includes receiving during an in-use phase, at the server 118, a wireless device identifier, such as the user device ID 206, of the wireless device 101 for which the method 700 will determine a fact of a visit to a given POI 134. In the in-use phase the MLA 158 uses dwelling profiles that were not previously used in training the MLA 158.

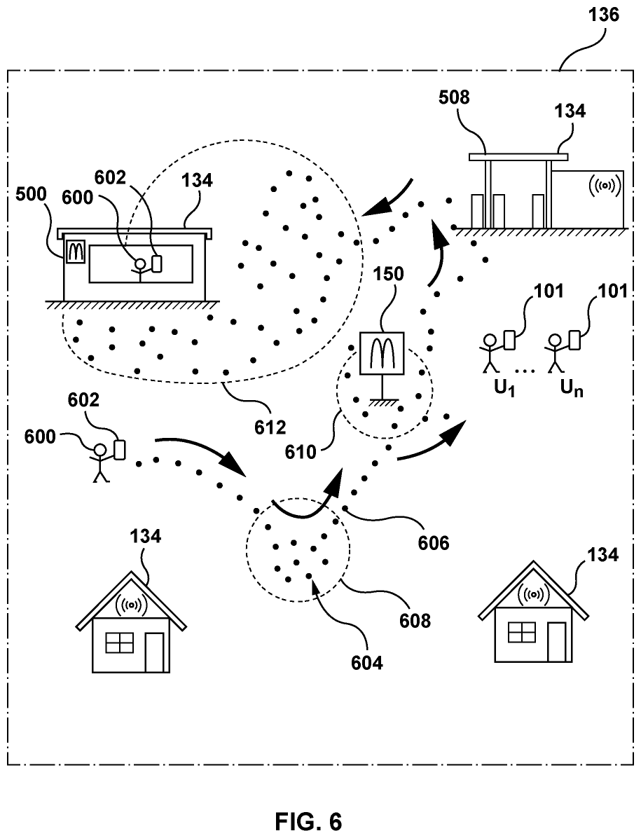

As a non-limiting example, and referring to FIG. 6, let's assume that the server 118 receives the wireless device identifier (in this example, the user device ID 206) of a wireless device 602 that is being used by a user 600. As described above, one example of the wireless device identifier is the user device ID 206.

Let's assume that a given POI 134 for which a fact of a visit by the user 600 is to be determined is the MacDonald's 500 in the geographical area 136.

Step 704—receiving during the in-use phase, at the server based on the wireless device identifier, a geo-track generated by the geo-location module.

In one embodiment, the method 700 may proceed with receiving, during the in-use phase, at the server 118 based on the wireless device identifier (in this example, the user device ID 206), a geo-track of the wireless device 602 of the user 600.

FIG. 6 shows an example geo-track 604 received from the wireless device 602. As shown, the geo-track 604 includes a plurality of different timestamped geo-locations 606 reported by the wireless device 602. The different timestamped geo-locations 606 are indicative of the user's 600 movement around the geographical area 136 over a pre-determined timeframe. To maintain clarity of the figure, only one of the timestamped geo-locations 606 has been labeled with the respective reference numeral.

In this example, the geo-track 604 shows that the user walked east near a residence (which may be a POI 134), then spent some time at a location between the residence (a POI 134) in the south west of the geographical area 136 and another residence (which may be a POI 134) in the south east of the geographical area 136. The user 600 then walked north and spent some time around the billboard 150, then walked further north and west, passed by the gas station 508 and arrived and spent some time in a vicinity of the MacDonald's 500.

Step 706—generating, based on the geo-track, a dwell profile of the wireless device of the user, the dwell profile being indicative of the wireless device of the user having been in a pre-defined vicinity of the location of the POI over a pre-determined timeframe.

In one embodiment, the method 700 may proceed with generating, based on the geo-track 604, one or more dwell profiles. The server 118 analyzes the geo-track 604 according to the steps described herein above. For conciseness, these steps are not repeated here. Suffice it to say that as described above, a given geo-track may reveal no dwell profiles or one or more dwell profiles.

In the present example shown in FIG. 6, the server 118 determines three different dwell profiles 608, 610 and 612 based on the geo-track 604. The server 118 determines that there are no POIs in the pre-defined vicinity (in this example, 150 meters) of the centroid of the dwell profiles 608 and 610. The server 118 thereby renders a determination that these dwell profiles 608, 610 do not correspond to a visit to any POI 134. In a way, this determination pre-filters out any of the dwell profile(s) of a given geo-track that are clearly indicative of no visit to any POI 134. In some embodiments, this pre-filtering step may be omitted.

The server 118 may further determine that the MacDonald's 500 and the gas station 508 are within the pre-defined vicinity (let's say 150 meters) of the centroid of the dwell profile 612, and that the time associated with the dwell profile 612 is 10 minutes.

Notably, by using the dwell profile determination procedure described above, some of the geo-locations 606 of the geo-track 604 are omitted from consideration due to having been determined to not belong to any dwell profile. In the example in FIG. 6, these omitted geo-locations 606 include those corresponding to when the user 600 walked by the gas station 508 without visiting it. Such omitted geo-locations 606 are not inputted into the MLA 158. Therefore, in at least some cases, using the dwell profiles of the present technology not only improves an accuracy of determinations of visits to particular POIs 134, but also improves efficiency of operation of the server 118.

As becomes clear from the above description, the efficiency is improved, inter alia, by not executing the MLA 158 with respect to every single geo-location 606 of every single user that is to be tracked using the methods of the present technology. This reduction reduces load on the server's 118 processor 122, memory 120 and other components, and thereby reduces an amount of energy consumed by the server 118 as well as increases speeds with which the server 118 executes the method 700 to track POI 134 visits by many different users.

Step 708—inputting, by the server into a Machine Learning Algorithm (MLA) as an in-use input, the dwell profile of the wireless device of the user, the MLA having been trained based on a training dataset, a given training object of the training dataset having been generated by: identifying a training set of sequential timestamped geo-tracked locations of a training wireless device associated with a training user based on a training wireless device identifier of the training wireless device, determining, based on the training sequential set of the geo-tracked locations, a training dwell profile of the training wireless device, the training dwell profile being indicative of the training wireless device having been in the pre-defined vicinity of the location of the POI over a pre-determined training timeframe, and applying a set of heuristics to the training sequential set of the geo-tracked locations and a user profile associated with the training user to generate a training label indicative of whether the training user has visited the location of the POI, thereby generating the given training object having the training dwell profile and the training label.

In one embodiment, the method 700 may proceed with inputting, by the server 118 into the MLA 158 as an in-use input, the dwell profile 612 of the wireless device 602 of the user 600.

At this stage, the MLA 158 had been trained based the training dataset as described above. The training has been described in detail above and is therefore not described again in detail.

Step 710—receiving during the in-use phase, by the server from the MLA as an in-use output based on the dwell profile, an indication of whether the user visited the POI.

In one embodiment, the method 700 may proceed with receiving during the in-use phase, by the server 118 from the MLA 158 as an in-use output based on the dwell profile 612, an indication of whether the user 600 visited the POI 134.

As shown in FIG. 6, in the present example, the user 600 did in fact visit the MacDonald's 500 at a time associated with the dwell profile 612. In the present example, the MLA 158 therefore based on the dwell profile 612 outputs an indication that the user 600 did visit the MacDonald's 500. In some embodiments, the indication includes a name and/or address and/or other identifier(s) of the particular POI 134 determined to be visited. Thus, in the above example, the indication may simply be: MacDonald's 500, Address: XYZ.

In some embodiments, the MLA 158 outputs a ranked list of potential POIs 134 being visited. In some embodiments, the rank list includes a “Yes” or a “No” indication next to each of the POIs 134 on the list, and the POIs 134 that are more likely to be visited are listed higher than the rest of the POIs 134 on the list. In some such embodiments, in the above example, the ranked list may indicate: 1) MacDonald's 500, “YES”, Address: XYZ.; 2) Petro-Canada, “NO”, Address: XYZ.

In other embodiments, the ranked list may indicate a probability of a visit to each of the POIs 134 on the ranked list. Thus, in the above example, the ranked list may indicate: 1) MacDonald's 500, 86% (probability of visit), Address: XYZ; 2) Petro-Canada, 14% (probability of visit), Address: XYZ.

Understandably, the method 700 may be executed with respect to each dwell profile 608, 610, 612 associated with the user's 600 wireless device 602 in embodiments in which the pre-filtering step described above is omitted. If this were the case in the example shown in FIG. 6, the method 700 would output an indication that no POI 134 was visited at the times associated with the dwell profiles 608 and 610.

In some embodiments, the determinations of visits executed according to the method 700 may be executed at or near real-time as new geo-location information associated with the user's 600 wireless device 602 becomes available. In other embodiments, the determinations of visits executed according to the method 700 may be executed for stored information containing geo-tracks associated with a particular period of time, such as a month for example.

The above example is given with respect to tracking POI visits of a single user. However, the method 700 may also be used to track and determine POI visits of a plurality of users to any one of the POIs 134 in the geographical area 136.

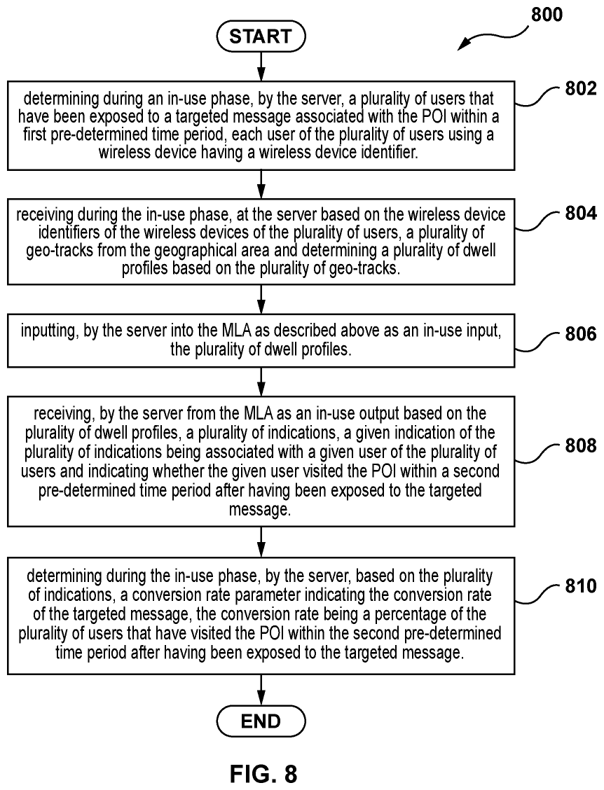

Yet other embodiments, applications and implementations of the method 700 are likewise contemplated. For example, with reference to FIG. 8, there is shown a method 800 that is executed using the method 700.

### Method of Determining a Conversion Rate of a Targeted Message

More particularly, the method 800 is a method of determining a conversion rate of a targeted message associated with a POI. As with the method 700, the method 800 may be executed at a server having a processor and a non-transient memory communicatively coupled to the processor, the non-transient memory storing processor-executable instructions thereon for executing the method.

Similar to the method 700, one example of a server suitable for executing the method 800 is the server 118. Therefore, the method 800 will be described herein next with regard to the server 118 for illustration.

Step 802—determining during an in-use phase, by the server, a plurality of users that have been exposed to a targeted message associated with the POI within a first pre-determined time period, each user of the plurality of users using a wireless device having a wireless device identifier.

In one embodiment, the method 800 starts at step 802, which includes determining during an in-use phase, by the server 118, a plurality of users that have been exposed to a targeted message associated with the target POI within a first pre-determined time period, each user of the plurality of users using a wireless device 101 having a wireless device identifier (in this example, the user device ID 206).

Referring also to FIG. 6, let's assume that the targeted message for which the method 800 will determine a conversion rate is shown on a billboard 150 and the targeted message directs viewers to the MacDonald's 500 (i.e. the target POI 134 in this example). Let's also assume that the pre-determined time period is a given day of a given week.

Further, let's assume that users U1 to Un, shown in FIG. 6, are determined by the server 118 to have been exposed to the targeted message displayed on the billboard 150 at various times during the given day of the given week.

In some non-limiting embodiments, this determination step is executed by the server 118 using the technology described in the U.S. Patent Application bearing the attorney docket number 40703-128, referred to above. It is contemplated that other methods for identifying users exposed to targeted messages could also be used.

Step 804—receiving during the in-use phase, at the server based on the wireless device identifiers of the wireless devices of the plurality of users, a plurality of geo-tracks from the geographical area and determining a plurality of dwell profiles based on the plurality of geo-tracks.

Once the time(s) of exposure of each of the users U1 to Un to the targeted message on the billboard 150 has been retrieved/determined by the server 118, the method 700 may proceed with receiving, during the in-use phase, at the server 118 based on the wireless device identifiers (in this example, the user device ID 206) of the wireless devices 101 of the plurality of users U1 to Un, a plurality of geo-tracks from the geographical area 136. The server 118 may then determine a plurality of dwell profiles based on the plurality of geo-tracks, using the same methodology of determining dwell profiles as described above.

In some embodiments, the plurality of geo-tracks are geo-tracks which are determined by the server 118 to have been generated by the wireless devices 101 at times occurring after each of the respective users U1 to Un was exposed to the targeted message on the billboard 150.

Some of the users U1 to Un may ignore the targeted message and move about the geographical area 136 without visiting the MacDonald's 500. Some of the users U1 to Un may be convinced by the targeted message and will actually make their way to the MacDonald's 500. The dwell profiles from each of these user's devices that are generated “post-exposure” to the targeted message will reflect these movements and visits when inputted into the MLA 158.

Step 806—inputting, by the server into the MLA as described above as an in-use input, the plurality of dwell profiles.

Once the dwell profiles are determined by the server 118, the method 800 may proceed with inputting dwell profiles, by the server 118 into the MLA 158, as an in-use input.

Step 808—receiving, by the server from the MLA as an in-use output based on the plurality of dwell profiles, a plurality of indications, a given indication of the plurality of indications being associated with a given user of the plurality of users and indicating whether the given user visited the POI within a second pre-determined time period after having been exposed to the targeted message.

The method 800 may proceed with receiving, by the server 118 from the MLA 158 as an in-use output based on the plurality of dwell profiles of the wireless devices 101, a plurality of indications. The indications may be implemented in any suitable form, such as one or more suitable data packets for each indication. The indications may be characterized as follows.

A given indication of the plurality of indications may be associated with a given user of the plurality of users U1 to Un and may indicate whether the given user visited the MacDonald's 500 within a second pre-determined time period after having been exposed to the targeted message on the billboard 150.

For the sake of the present non-limiting example, let's assume that the second pre-determined time period is equal to five hours. Hence, at this step, each given indication is indicative of whether or not a given one of the users U1 to Un visited the MacDonald's 500 within five hours of having been exposed to the targeted message on the billboard 150. Understandably, the five hours is just an example and the value of the second pre-determined time period could be different.

Step 810—determining during the in-use phase, by the server, based on the plurality of indications, a conversion rate parameter indicating the conversion rate of the targeted message, the conversion rate being a percentage of the plurality of users that have visited the POI within the second pre-determined time period after having been exposed to the targeted message.

In one embodiment, the method 800 may proceed by determining, during the in-use phase, by the server 118, based on the plurality of indications, a conversion rate parameter indicating the conversion rate of the targeted message. In some non-limiting embodiments, the conversion rate is a percentage of the plurality of users that have visited a POI 134 targeted by a given targeted message within the second pre-determined time period after having been exposed to the targeted message.

Thus, in the present non-limiting example, the conversion rate is a percentage of the users U1 to Un that visited the MacDonald's 500 within the five hours following being exposed to the targeted message on the billboard 150.

While the method 800 is described above with respect to one particular example of a time, a particular a POI, and a particular offline targeted message, it is contemplated that the method 800 could be used to determine conversion rates for many different POIs, over different time frames, and for different types of targeted messages. It is contemplated that the targeted messages could be offline targeted messages, online targeted message, and/or combinations thereof.

### Method of Determining Place Visits Lift

The present technology further provides for an additional particular way of using the method 700. Namely, the present technology provides for a method 900 of determining a Place Visits Lift (PVL) metric, or simply PVL.

The present technology relating to determining the PVL has been developed with the developers' appreciation that when targeted messages are directed to an offline site, such as a POI (see for example POIs 134 in FIG. 6), it is difficult to determine an efficacy of the targeted messages in directing users that were exposed to the targeted messages to the POIs that the targeted messages target. More particularly, it has been appreciated by the developers that the difficulty with determining an efficacy of targeted messages in increased at least in some cases when the targeted messages are online but the POIs that the targeted messages are directed to are offline (see for example, physical POIs 134 in FIG. 6).

In some non-limiting embodiments, determining PVL according to the present technology allows to quantify an efficacy of a given targeted message in directing users to a particular POI to which the given targeted message relates. In an aspect, increases in PVL may be said to be indicative of a measure of how much more users were persuaded by a given one or more targeted messages to visit the particular POIs that the targeted messages relate to, in comparison with users who were not exposed to the given one or more targeted messages.

Monitoring the PVL for given one or more targeted messages according to the present technology therefore allows to determine which one(s) of the given one or more targeted messages are under-performing, performing, or over-performing. Accordingly, the present technology may allow provider(s) of the given one or more targeted messages to, for example, remove under-performing targeted messages from being displayed to users and may thereby allow for resources associated with displaying such targeted messages to be reduced and/or saved. Other uses of PVL determined according to the present technology are likewise contemplated.

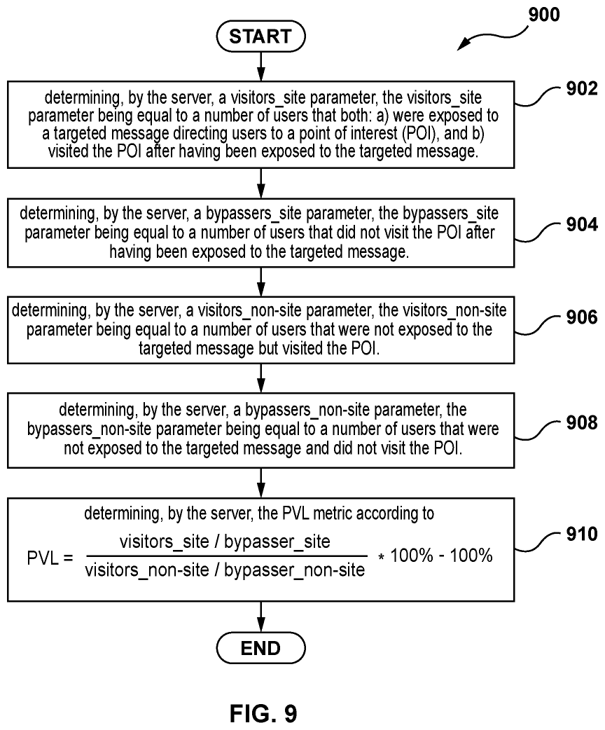

A particular non-limiting embodiment of the method 900 for determining PVL according to the present technology is shown in FIG. 9, referred to next. The method 900 is executable at a server having a processor and a non-transient memory communicatively coupled to the processor, the non-transient memory storing processor-executable instructions thereon for executing the method. An example of a suitable server is server 118, described above. Thus, for simplicity and not to be limiting, the method 900 will be described and illustrated with regard to the server 118.

Step 902—determining, by the server, a visitors_site parameter, the visitors_site parameter being equal to a number of users that both: a) were exposed to a targeted message directing users to a point of interest (POI), and b) visited the POI after having been exposed to the targeted message.

In one embodiment, the method 900 starts at step 902, which includes determining, by the server 118, a visitors_site parameter.

In some non-limiting embodiments, the visitors_site parameter is equal to a number of users that were to have both: a) been exposed to a targeted message directing users to a point of interest (POI), and b) visited the POI after having been exposed to the targeted message.

As a non-limiting example, let's say the targeted message is an indication, posted on the billboard 150 shown in FIG. 6, that a deal is available for one of the products offered at the MacDonald's 500 in the geographical area 136. According to this non-limiting example then, the POI, or the target POI, of the targeted message is the MacDonald's 500 shown in FIG. 6.

In this non-limiting example, the facts and times of each of the users being exposed to the targeted message may be determined using the technology described in the U.S. Patent Application bearing the attorney docket number 40703-128, referred to above.

Further in this non-limiting example, the facts of the visits, or simply the visits, and the associated times of the visits of each of the (identified) users may be determined according to the method 700 described above.

Step 904—determining, by the server, a bypassers_site parameter, the bypassers_site parameter being equal to a number of users that did not visit the POI after having been exposed to the targeted message.

In some non-limiting embodiments, the method 900 may proceed by determining, by the server, a bypassers_site parameter, the bypassers_site parameter being equal to a number of users that did not visit the POI after having been exposed to the targeted message.

In this non-limiting example, for each given user of one of the wireless devices 101 that was determined to have been exposed to the targeted message displayed on the billboard 150, the method 700 described above may be used to monitor the given user's activity for at least a pre-determined period of time after the exposure.

More particularly, the method 700 may be used to determine whether at any given point in time (or at multiple given points in time) during the pre-determined period of time after the exposure, the user visited the MacDonald's 500.

Step 906—by the server, a visitors_non-site parameter, the visitors_non-site parameter being equal to a number of users that were not exposed to the targeted message but visited the POI.

In one embodiment, the method 900 may proceed by determining a visitors_non-site parameter. In some non-limiting embodiments, the visitors_non-site parameter is equal to a number of users that were not exposed to the targeted message but visited the POI.

Similar to above, the facts and times of visits may be determined by the method 700, and exposures to the targeted message may be determined using the technology described in the U.S. Patent Application bearing the attorney docket number 40703-128, referred to above.

Step 908—determining, by the server, a bypassers_non-site parameter, the bypassers_non-site parameter being equal to a number of users that were not exposed to the targeted message and did not visit the POI.

In one embodiment, the method 900 may proceed by determining a bypassers_non-site parameter. In some non-limiting embodiments, the bypassers_non-site parameter is equal to a number of users that were not exposed to the targeted message and did not visit the POI.

Similar to above, the facts and times of visits may be determined by the method 700, and lack of exposures to the targeted message may be determined using the technology described in U.S. Patent Application bearing the attorney docket number 40703-128, referred to above.

Step 910—determining, by the server, the PVL metric.

Once all of the above parameters are determined, the method 900 may proceed to determining the PVL metric based on the determined parameters.

According to the present technology, the PVL metric is determined by the server 118, based on the parameters described above, according to the following formula:

$$PVL = \frac{visitors\_site / bypassers\_site}{visitors\_non \text{-} site / bypassers\_non \text{-} site} * 100 \% - 100 \% , \qquad Formula 1$$

where, each of the parameters has the corresponding one of the definitions given above in the earlier steps of the method 900.

It is contemplated that in some embodiments, some but not all of the abovementioned parameters may be determined according to the present technology. While the particular targeted message used to illustrate method 900 is an offline targeted message, in some non-limiting embodiments, the method 900 is used to determine PVL for online targeted messages.

Modifications and improvements to the above-described implementations of the present technology may become apparent to those skilled in the art. The foregoing description is intended to be exemplary rather than limiting.

While particular orders of methods steps have been set out herein above, it is contemplated that other orders of method steps and/or additional and/or alternative method steps could be used to carry out the methods described herein.

Modifications and improvements to the above-described implementations of the present technology may become apparent to those skilled in the art. The foregoing description is intended to provide specific non-limiting implementations of the present technology.

1. A method of determining a fact of a visit of a user to a point of interest (POI), the user using a wireless device having a geo-location module and a wireless device identifier, the POI being in a location, the method being executed at a server having a processor and a non-transient memory communicatively coupled to the processor, the non-transient memory storing processor-executable instructions thereon for executing the method, the method comprising:
receiving during an in-use phase, at the server, the wireless device identifier of the wireless device;
receiving during the in-use phase, at the server based on the wireless device identifier, a geo-track generated by the wireless device;
generating, based on the geo-track, a dwell profile of the wireless device of the user, the dwell profile being indicative of the wireless device of the user having been in a pre-defined vicinity of the location of the POI over a pre-determined timeframe;
inputting, by the server into a Machine Learning Algorithm (MLA) as an in-use input, the dwell profile of the wireless device of the user, the MLA having been trained based on a training dataset, a given training object of the training dataset having been generated by:
identifying a training set of sequential timestamped geo-tracked locations of a training wireless device associated with a training user based on a training wireless device identifier of the training wireless device,
determining, based on the training sequential set of the geo-tracked locations, a training dwell profile of the training wireless device, the training dwell profile being indicative of the training wireless device having been in the pre-defined vicinity of the location of the POI over a pre-determined training timeframe, and
applying a set of heuristics to the training sequential set of the geo-tracked locations and a user profile associated with the training user to generate a training label indicative of whether the training user has visited the location of the POI,
thereby generating the given training object having the training dwell profile and the training label;
receiving during the in-use phase, by the server from the MLA as an in-use output based on the dwell profile, an indication of whether the user visited the POI.

2. The method of claim 1, wherein the generating the dwell profile of the wireless device comprises:
analyzing the geo-track generated by the geo-location module, the geo-track having a set of timestamped geo-tracked locations received from the geo-location module of the wireless device; and
the set of timestamped geo-tracked locations including a sequential set of the geo-tracked locations that are both within the pre-defined vicinity of the location of the POI and have timestamps that correspond to the pre-determined timeframe.

3. The method of claim 1, wherein the user profile comprises a user specific portion and a device specific portion.

4. The method of claim 2, wherein the set of heuristics comprises a first subset of heuristics applicable to the user specific portion, and the first subset of heuristics being configured for executing a determination that the training user interacted with a resource associated with the POI, the resource including at least one of a telephone line associated with the POI, and a website associated with the POI.

5. The method of claim 3, wherein the first subset of heuristics is further configured for executing a determination that the training user interacted with a web resource and the interaction with the web resource included a web search by the training user of the POI in the web resource.

6. The method of claim 5, wherein the web resource is a map service and the web search was in the map service for the POI, the web search having been executed by the training user.

7. The method of claim 3, wherein the set of heuristics comprises a second subset of heuristics applicable to the device specific portion, and the second subset of heuristics is for executing a determination based on the set of timestamped geo-tracked locations that the training user moved to within the pre-determined vicinity of the location of the POI.

8. The method of claim 7, wherein the second subset of heuristics is further configured for executing a determination that the training user was exposed to a targeted message associated with the POI before having moved to within the pre-determined vicinity of the location of the POI.

9. The method of claim 8, wherein the targeted message is an online targeted message.

10. The method of claim 8, wherein the targeted message is an offline targeted message.

11. The method of claim 8, wherein the second subset of heuristics is further configured for executing a determination that the training user moved to within the pre-determined vicinity of the location of the POI in within a pre-determined time limit after having been exposed to the targeted message.

12. The method of claim 11, wherein the pre-determined time limit is less than five hours.

13. The method of claim 7, wherein the pre-determined vicinity is defined by a radius around the location of the POI, the radius being five hundred meters.

14. The method of claim 7, wherein the pre-determined vicinity is defined by a radius around the location of the POI, the radius being one hundred and fifty meters.

15. The method of claim 7, wherein the second subset of heuristics is further configured for executing a determination that the training wireless device connected, via the training communication module, to a local area network (LAN) associated with the POI.

16. The method of claim 1, wherein the timestamp of each geo-tracked location in the sequential set of the geo-tracked locations is indicative of a time that occurred at least a pre-determined time-distance after the time indicated by the timestamp of a geo-tracked location preceding that geo-tracked location.

17. The method of claim 1, wherein each geo-tracked location in the sequential set of the geo-tracked locations is no more than a pre-determined distance away from another geo-tracked location in the sequential set of the geo-tracked locations.

18. The method of claim 18, wherein:
the sequential set of the geo-tracked locations includes a first sequential subset of geo-tracked locations and a second sequential subset of geo-tracked locations;
a time difference between a last-in-time geo-tracked location of the first sequential subset of geo-tracked locations and a first-in-time geo-tracked location of the second sequential subset of geo-tracked locations does not exceed a pre-determined time difference threshold;
each of the first and second sequential subsets of geo-tracked locations has a centroid determined based on the geo-tracked locations of that subset of geo-tracked locations; and
a distance between the centroids of the first and second sequential subsets of geo-tracked locations does not exceed a pre-determined centroid-to-centroid distance threshold.

19. A method of determining a Place Visit Lift (PVL) metric, the method being executed at a server having a processor and a non-transient memory communicatively coupled to the processor, the non-transient memory storing processor-executable instructions thereon for executing the method, the method comprising:
determining, by the server, a visitors_site parameter, the visitors_site parameter being equal to a number of users that both: a) were exposed to a targeted message directing users to a point of interest (POI), and b) visited the POI after having been exposed to the targeted message;
determining, by the server, a bypassers_site parameter, the bypassers_site parameter being equal to a number of users that did not visit the POI after having been exposed to the targeted message;
determining, by the server, a visitors_non-site parameter, the visitors_non-site parameter being equal to a number of users that were not exposed to the targeted message but visited the POI;
determining, by the server, a bypassers_non-site parameter, the bypassers_non-site parameter being equal to a number of users that were not exposed to the targeted message and did not visit the POI; and
determining, by the server, the PVL metric according to the following formula:
$$PVL = \frac{visitors\_site / bypassers\_site}{visitors\_non \text{-} site / bypassers\_non \text{-} site} * 100 \% - 100 \% ,$$
at least one of the parameters being determined using the method of any one of claims 1 to 24.

20. A method of determining a conversion rate of a targeted message associated with a POI, the method being executed at a server having a processor and a non-transient memory communicatively coupled to the processor, the non-transient memory storing processor-executable instructions thereon for executing the method, the method comprising:
determining during an in-use phase, by the server, a plurality of users that have been exposed to a targeted message associated with the POI within a first pre-determined time period, each user of the plurality of users using a wireless device having a geo-location module and a wireless device identifier;
receiving during the in-use phase, at the server based on the wireless device identifiers of the wireless devices of the plurality of users, a plurality of geo-tracks from the geographical area and determining a plurality of dwell profiles based on the plurality of geo-tracks;
inputting, by the server into the MLA of claim 1 as an in-use input, the plurality of dwell profiles;
receiving, by the server from the MLA as an in-use output based on the plurality of dwell profiles, a plurality of indications, a given indication of the plurality of indications being associated with a given user of the plurality of users and indicating whether the given user visited the POI within a second pre-determined time period after having been exposed to the targeted message; and
determining during the in-use phase, by the server, based on the plurality of indications, a conversion rate parameter indicating the conversion rate of the targeted message, the conversion rate being a percentage of the plurality of users that have visited the POI within the second pre-determined time period after having been exposed to the targeted message.
